(19) United States
(12) Patent Application Publication
(10) Pub. No.: US 2009/0102274 A1
(43) Pub. Date: Apr. 23, 2009

(54) Vehicle Rim With Non-Matching Diameter Seats

(75) Inventors: Michel Malevergne, Cebazat (FR); Nicolas Grolier, Clermont-Ferrand (FR)

Correspondence Address: FITZPATRICK CELLA HARPER & SCINTO, 30 ROCKEFELLER PLAZA, NEW YORK, NY, 10112, US

(73) Assignee: MICHELIN RECHERCHE ET TECHNIQUE S.A., Granges-Paccot (SW)

(21) Appl. No.: 11/994,687

(22) PCT Filed: Jul. 3, 2006
(86) PCT No.: PCT/EP2006/063790

§ 371 Date: Jun. 10, 2008

(30) Foreign Application Priority Data
Jul. 4, 2005 (FR) 05/07099
Jul. 11, 2005 (FR) 05/07424

(51) Int. Cl. B60B 21/02

(52) U.S. Cl. 301/95.109

(57) ABSTRACT

A vehicle rim with symmetry of revolution intended for mounting a tire, including a first seat intended to receive and retain a first bead of the tire; a mounting groove; and a second seat intended to receive and retain a second bead of the tire, the second seat being of an average diameter smaller than the average diameter of the first seat, characterized in that the maximum radial depth of the mounting groove (Hₘₐₓ) is such that the second bead can negotiate the first seat.

### BACKGROUND OF THE INVENTION

1. Field of the Invention

The present invention relates to a vehicle rim comprising two seats of different diameters and which is intended for mounting a tire, and to a method for mounting a tire on this rim.

2. Description of Related Art

Vehicle rims in which the two seats have different diameters are already known in the state of the art. By way of example, document EP 1 002 667 A1 discloses a tire and a rim in which the larger-diameter seat is positioned on the outboard side of the vehicle to improve ride and comfort. Document WO 02/055325 A1 discloses a method of mounting a tire and a support on a rim the two seats of which are of different diameters. The mounting method consists in slipping the larger-diameter bead of the tire and the support around the rim from the smaller-diameter rim seat. A mounting groove adjacent to the larger-diameter rim seat is then used to cause the larger-diameter bead of the tire to negotiate this rim seat.

### BRIEF DESCRIPTION OF THE INVENTION

A subject of the invention is a vehicle rim with symmetry of revolution intended for mounting a tire, comprising a first seat intended to receive and retain a first bead of the tire, a mounting groove and a second seat intended to receive and retain a second bead of the tire, the second seat being of an average diameter smaller than the average diameter of the first seat, characterized in that the maximum radial depth of the mounting groove (Hₘₐₓ) is such that the second bead can negotiate the first seat.

This rim has the advantage that it allows the tire to be mounted on the rim starting by making the small diameter bead of the tire negotiate the large-diameter seat.

As a preference, the maximum radial depth of said mounting groove (Hₘₐₓ) is a function of the maximum diameter (Ø_{S1max}) of the first seat and of the minimum diameter (Ø_{S2min}) of the second seat:

$${H}_{max} = \frac{( {Ø}_{S 1 max} - {Ø}_{GM min} )}{2} = F ( {Ø}_{S 1 max} , {Ø}_{S 2 min} )$$

where Ø_{GMmin} is the minimum diameter of the mounting groove.

Advantageously, with the mounting groove having a first sidewall adjacent to the first seat, a bottom and a second sidewall adjacent to the second seat, the minimum diameter region (Ø_{GMmin}) of the mounting groove is adjacent to the first sidewall.

According to another feature of the rim according to the invention, the minimum depth of the bottom of the mounting groove (Hₘᵢₙ) is a function of the maximum (Ø_{S2max}) and minimum (Ø_{S2min}) diameters of the second seat:

$${H}_{min} = \frac{{Ø}_{S 2 max} - {Ø}_{GM max}}{2} = G ( {Ø}_{S 2 max} , {Ø}_{S 2 min} )$$

where Ø_{GMmax} is the maximum diameter of the bottom of the mounting groove.

According to a preferred embodiment, the bottom of the mounting groove comprises a zone that is substantially cylindrical of revolution followed, on the same side as the second seat, by a frustoconical zone that locally coincides with a cone of revolution open towards the said second seat.

What is meant by a zone that is substantially cylindrical of revolution is a zone that is cylindrical of revolution but also a zone that locally coincides with a large-diameter torus of revolution or alternatively with a cone of very small cone angle, for example a few degrees.

This text employs the common definition of a cone of revolution, namely that is a solid of revolution on a circular base ending in a tip.

As a preference, the zone that is substantially cylindrical of revolution and the frustoconical zone are separated by a hump.

This hump may locally coincide with a first torus of revolution coaxial with the rim and external to the said rim and then, on the same side as the second seat, with a second torus of revolution coaxial with the rim and internal to the said rim. These two toruses may be connected by a zone that is frustoconical of revolution.

The mathematical definition of a torus, as used herein, is a surface of revolution generated by a circle rotating about an axis located in its plane but not passing through its centre.

Advantageously, the first seat is intended to be positioned on the outboard side of a vehicle.

This preferred embodiment allows the tire to be mounted on the rim with the customary attachment of wheel discs to the tire-mounting machines.

By way of example, the first seat may comprise:

a frustoconical bottom which locally coincides with a cone of revolution coaxial with the rim and open towards the second seat,

a safety hump extending the bottom of the first seat towards the second seat, and

an outer edge extending the bottom of the first seat on the opposite side to the second seat.

The second seat may also comprise:

a frustoconical bottom which locally coincides with a cone of revolution coaxial with the rim and open towards the first seat,

a safety hump extending the bottom of the second seat towards the first seat, and

an outer edge extending the bottom of the first seat on the opposite side to the second seat.

Another subject of the invention is a method of mounting a tire on a wheel as previously described, in which:

part of the second bead is inserted into the mounting groove of the rim, negotiating the first seat;

the second bead of the tire finishes negotiating the first seat;

the second bead of the tire is made to negotiate the second seat; and

the two beads of the said tire are placed on the respective seats of the said rim.

The order in which the two beads are placed is immaterial. It is also possible to place them simultaneously.

Advantageously, while inserting part of the second bead into the mounting groove of the rim, this part of the second bead is immobilized against the intermediate hump of the said mounting groove.

This hump allows that part of the bead that has already negotiated the first seat to remain immobilized near the sidewall adjacent to the first seat so that negotiation of the first seat can thus be completed with ease.

As an option, once the second bead of the tire finishes negotiating the first seat:

the tire is rotated about an axis perpendicular to the axis of the wheel so that at least the second bead straddles the second seat of the said rim; then

the two beads of the said tire are placed in turn on the respective seats of the said rim using a tire-mounting roller.

This step is particularly advantageous when the tire to be mounted is a tire of which the beads, in the state of rest, have a separation smaller than or equal to the width of the rim. Such tires may have relatively rigid sidewalls, such as those of a low profile tire or of a self supporting tire.

As a preference, in order to position a bead that is straddling a rim seat:

the fitting of the said bead on the said seat starts with a relative axial rotational movement of the tire and of the rim;

a tire-mounting roller is positioned to bear axially partially against the outer edge of the seat of the said rim and partially against the bead of the said tire in the region where the bead is in place on the said seat; and

the wheel and tire assembly is rotated in a direction of rotation such that the tire-mounting roller comes into contact with that part of the bead that is positioned on the outside of the seat and is not yet in place on the said seat and this is continued until the said bead is fully in place on the said seat.

Another subject of the invention is a method of removing a tire from a wheel comprising a rim as described previously, in which:

the first bead is dislodged from its seating axially outwards;

the second bead is made to negotiate the safety hump of the second seat axially in the direction of the mounting groove;

the second bead is moved towards the first seat of the said rim while bearing against the hump of the said mounting groove; and

the second bead is made to negotiate the first seat.

The order of the first two removal operations is immaterial. It may be advantageous in some cases to start by making the second bead negotiate the safety hump of the second seat axially in the direction of the mounting groove, in particular in the case of tires having rigid sidewalls.

These mounting and removal operations can advantageously be performed using devices such as tire-mounting rollers, presses and removal bars as described in document EP 1194305. Such devices are well known to those skilled in the art.

Other subjects of the invention are a vehicle rim as previously described and made from sheet metal and a vehicle wheel characterized in that it consists of a rim and of a disc each made from sheet metal and in that the disc and the rim are assembled by fitting them together under the part of the mounting groove that is adjacent to the first seat of the rim.

### BRIEF DESCRIPTION OF THE DRAWINGS

Other features and advantages of the invention will become apparent from the description given hereinafter with reference to the attached drawings, in which, by way of nonlimiting examples, show some embodiments of the subject matter of the invention:

FIG. 1 presents a schematic depiction, viewed in axial part section, of a rim according to the invention;

FIGS. 2 to 6 illustrate the successive phases in mounting a tire on the rim of FIG. 1;

FIGS. 7 and 8 show alternative steps in mounting a tire on the rim of FIG. 1;

FIGS. 9 and 10 illustrate the successive phases of removing a tire from the rim of FIG. 1; and

FIG. 11 shows a wheel with a second embodiment of a rim according to the invention.

### DESCRIPTION OF ONE OF MORE EMBODIMENTS OF THE INVENTION

The meridian or axial plane is to be understood to mean any plane passing through the axis A of the wheel and of the rim.

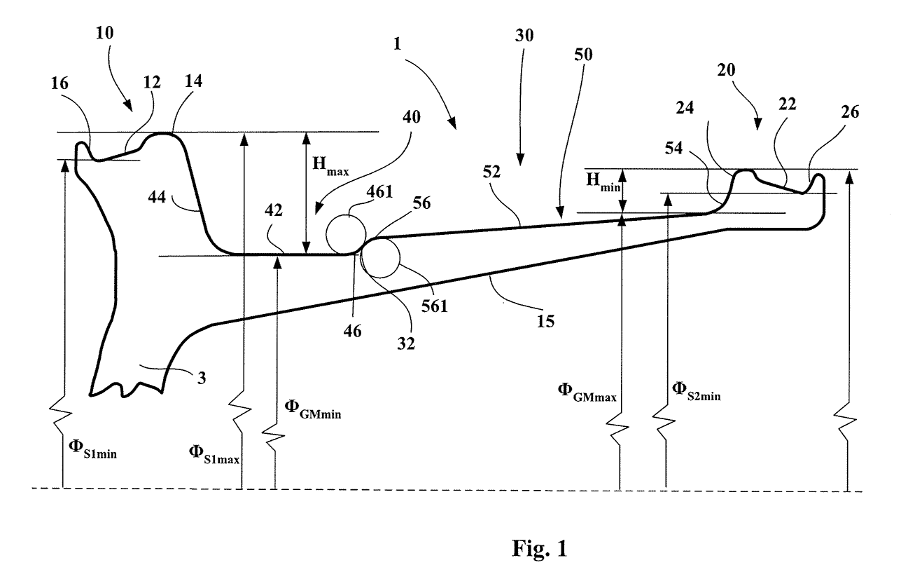

FIG. 1 shows, in partial meridian or axial section, a one-piece rim 1 according to the invention. This rim, together with a disc 3, forms a one-piece wheel. The disc can also be manufactured independently of the rim and joined to the latter thereafter. The rim 1 comprises a first seat 10 and a second seat 20 which seats are intended to act as bearing surfaces for the beads of a tire.

The first seat 10 has a frustoconical bottom 12 which locally coincides with a cone of revolution coaxial with the rim and open towards the second seat 20, a safety hump 14 extending the bottom 12 of the first seat 10 towards the second seat 20 and an outer edge 16 extending the bottom 12 of the first seat on the opposite side to the second seat 20. The minimum diameter of the first seat 10 is Ø_{S1min}. This diameter corresponds to the diameter of the circle where the frustoconical bottom 12 and the outer edge 16 meet. The maximum diameter of the first seat 10 is Ø_{S1max}. This diameter corresponds to the maximum diameter of the safety hump 14.

The second seat 20 comprises a frustoconical bottom 22 which locally coincides with a cone of revolution coaxial with the rim and open towards the first seat 10, a safety hump 24 extending the bottom 22 of the second seat 20 towards the first seat 10, and an outer edge 26 extending the bottom 22 of the second seat on the opposite side to the first seat 20. The minimum diameter of the second seat 10 is Ø_{S2min}. This diameter corresponds to the diameter of the circle where the frustoconical bottom 22 and the outer edge 26 meet. The maximum diameter of the second seat 20 is Ø_{S2max}. This diameter corresponds to the maximum diameter of the safety hump 24.

The mean diameter of the second seat is smaller than that of the first seat. In the example depicted, the order of magnitude of the difference between the minimum diameters Ø_{S1min}−Ø_{S2min} is of the order of 20 mm. The difference between the minimum radii of the two seats is therefore of the order of 10 mm.

Between the two seats 10 and 20 there is a mounting groove 30. This groove comprises two parts 40, 50, separated by an intermediate hump 32.

The first part of the mounting groove 40 is adjacent to the first seat 10. It has a substantially cylindrical bottom 42, a sidewall 44 connecting with the safety hump 14 of the first seat 10 and a first part 46 of the hump 32 that makes the connection with the second groove 50. The minimum diameter Ø_{GMmin} of the mounting groove 30 corresponds to the diameter of the bottom 42, which is substantially cylindrical of revolution, of the first mounting groove 40. The axial width of the bottom 42 is of the order of 30 to 40 mm. It should be noted that the effectiveness of the first part 40 of the groove 30 is maximized when the axial width of the bottom 42 is minimized. The limit is reached when the width of this bottom 42 becomes substantially equal to the axial dimension of the tire bead. The range from 30 to 40 mm satisfies these two requirements.

The second part of the mounting groove 50 is adjacent on one side to the first groove and on the other to the safety hump 24 of the second seat 20. It has a substantially frustoconical bottom 52 which locally coincides with a cone of revolution open towards the second seat 20, a sidewall 54 connecting with the safety hump 24 and the second part 56 of the hump 32 for connecting with the first mounting groove 40. The maximum diameter Ø_{GMmax} of the mounting groove 30 corresponds to the diameter where the frustoconical bottom 52 and the connecting sidewall 54 meet.

In the exemplary embodiment depicted in FIG. 1, the hump 32 comprises a first part 46 that locally coincides with a torus of revolution 461 coaxial with the rim and external thereto, and a second part 56 which locally coincides with a torus of revolution 561 coaxial with the rim and internal thereto.

On the radially inner side, the rim 1 has a wall 15 the diameter of which decreases continuously from the second seat 20 towards the region of connection with the disc 3.

The purpose of a mounting groove is to allow a tire bead to negotiate a rim seat of a larger diameter when the tire is being mounted onto the rim. Mounting is performed by inserting part of the bead into the mounting groove and then passing the rest of the bead over the seat while rotating the tire-wheel assembly and pressing the bead towards the inside of the wheel using a tire-mounting roller. This purpose is well known to all those skilled in the art of tires and wheels.

To a first approximation then, the depth of the mounting groove is thus a function of the inside diameter of the bead of the tire which is close to the minimum diameter of the seat of the rim and to the maximum diameter of the seat. The special geometry of the rim seat therefore plays a part. However, there is no mathematical relationship that determines the minimum depth of the mounting groove, and its precise design is determined experimentally.

The wheel according to the invention is characterized in that the depth of the mounting groove is such that the second bead with the smaller mean diameter can negotiate the first seat with the higher mean diameter. As a result, the tire can be mounted on the rim according to the invention starting by causing the second bead to negotiate the first seat. That means that tire fitters' practices need to be modified as little as possible and, in particular, when the first seat is positioned on the outboard side of the vehicle, that is to say on the side where the disc 3 is connected to the rim, the tire can be mounted “from the front” without the need to invert the position of the wheel on the tire-mounting machine by comparison with its customary position.

The depth of the wheel according to the invention is therefore determined as a function of the maximum diameter of the first seat Ø_{S1max} and of the minimum diameter of the second seat Ø_{S2min} rather than taking account of the minimum and maximum diameters of the second seat alone as was the case with the rim disclosed in application WO 02/055325 A1. In the example depicted, the value of Hₘₐₓ is of the order of 35 to 50 mm and of Hₘᵢₙ is of the order of 13 to 16 mm depending on the diameter of the rim. It is for smaller rim diameters that the depth of the mounting groove needs to be at its largest, when there is no change in the geometry of the rim seats.

It should be noted that the deeper mounting groove is positioned adjacent to the larger diameter seat.

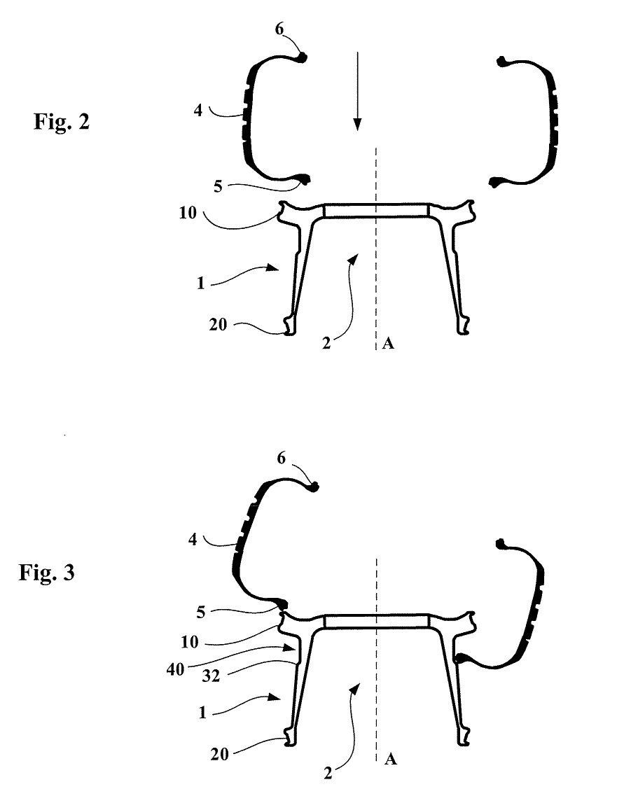

FIGS. 2 to 8 schematically describe the successive steps in mounting a tire on the rim of the invention.

FIG. 2 shows a rim 1 of a wheel 2 mounted on a tire-mounting machine or vertical axis, not depicted. This rim comprises a larger-diameter seat 10 and a smaller-diameter seat 20. The rim is positioned with its larger diameter seat “uppermost”. The disc, connected to the outboard side of the rim, faces the machine operator. The tire 4 in particular has two beads 5, 6 of different diameters designed to be positioned on the seats 10 and 20 of the rim 1. The tire is positioned in such a way that the smaller-diameter bead 5 is ready to be fitted around the seat 10 of the rim.

FIG. 3 shows part of the bead 5 of the tire 4 positioned in the bottom of the mounting groove 40 while the symmetric part is still on the outside of the seat 10. It should be noted that the part of the bead that lies in the bottom of the groove 40 is immobilized against the hump 32 separating the two parts 40 and 50 of the mounting groove 30 of the rim 1. That allows the tire to maintain a limited angle of inclination relative to the vertical axis this being highly beneficial for ease of negotiation by the remainder of the bead 5. Without this hump, the tire would have a tendency to slide along the bottom of the mounting groove and might reach a position that is steeply enough inclined that the bead 5 can no longer continue to negotiate the seat 10. The seat is fully negotiated in the known way by rotating the tire and wheel assembly and by using a tire-mounting roller 60 exerting downward pressure.

When the bead 5 has completely negotiated the seat 10, it is brought progressively over the intermediate hump 32 as far as the end of the mounting groove 50 against the sidewall 54 adjacent to the seat 20. The bead 5 is then made to negotiate this second seat 20 in the known way, using tire levers for example. The assembly is then in the position illustrated in FIG. 4 in which the two beads 5 and 6 are placed externally relative to the seats 10 and 20.

FIGS. 5 and 6 illustrate the successive placement of the two beads 5 and 6 on the seats 20 and 10 respectively using tire-mounting rollers.

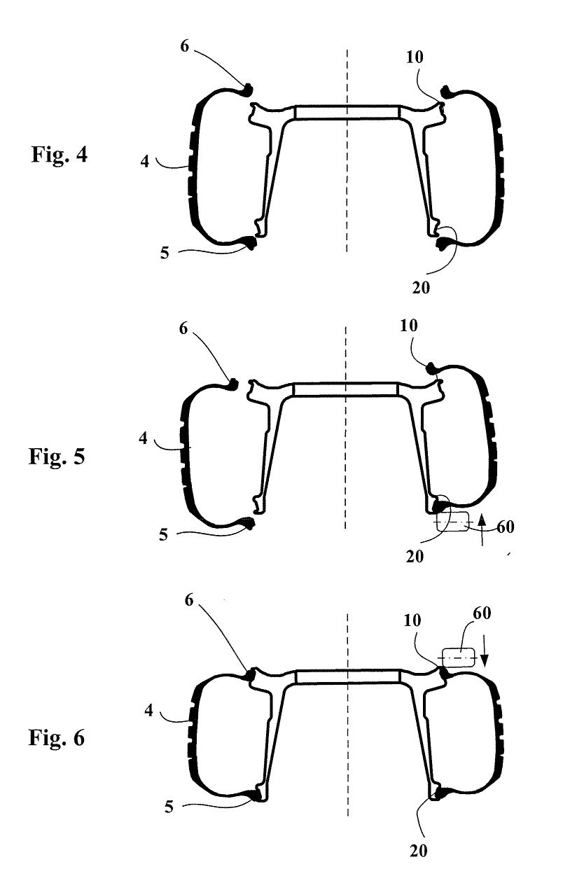

FIG. 7 illustrates an alternative form of the mounting method according to the invention. After the step illustrated by FIG. 3 it is difficult, with certain tires, to bring them into the position illustrated by FIG. 4 because they have rigid sidewalls or because of their position of equilibrium at rest. In such cases, the tire is rotated about an axis perpendicular to the axis of the wheel so that at least the second bead straddles the rim seat 20. In practice, this rotation often brings the two beads into a similar position, straddling their respective seats (FIG. 7).

The two beads are then positioned in succession as follows:

the fitting of the bead 5 on the seat 20 starts with a relative axial rotational movement of the tire and of the rim;

a tire-mounting roller 60 is positioned to bear axially partially against the outer edge of the seat 20 of the rim 1 and partially against the bead 5 of the tire in the region where the bead is in place on the said seat 20;

the wheel and tire assembly is rotated in a direction of rotation such that the tire-mounting roller 60 comes into contact with that part of the bead that is positioned on the outside of the seat and is not yet in place on the seat and this is continued until the bead is fully in place on the seat (FIG. 8). FIG. 8 illustrates the fitting of the bead 5 onto the seat 20 when the bead 6 has been fitted onto the seat 10 already using a similar method. It is of no importance which of the beads is fitted first.

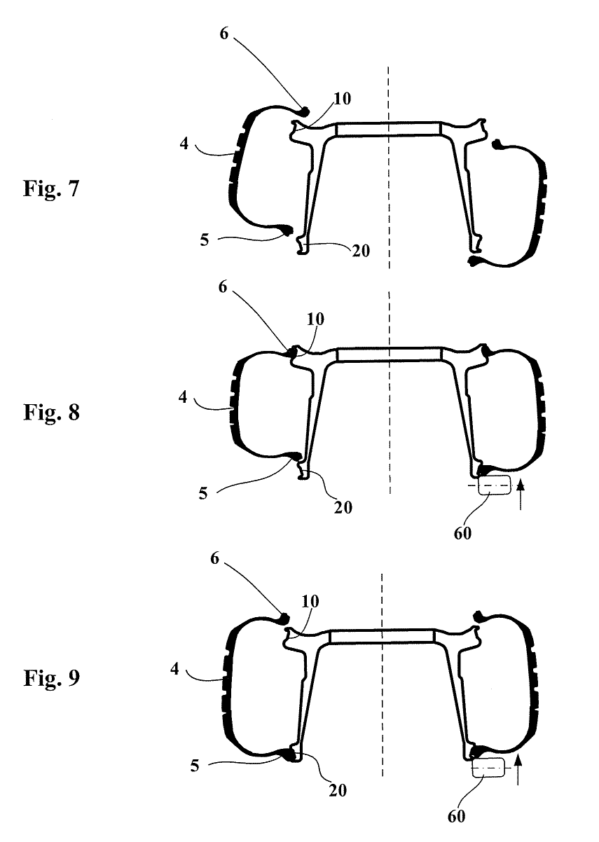

FIGS. 9 and 10 illustrate the method of removing the tire from the rim 1 according to the invention.

The first step, as described in WO 00/78567 A1, is to extract the bead 6 from the seat 10 outwards. This extraction consists in inserting into a lubricated gap between the toe of the bead 6 and the seat 10 a removal insert in the form of a portion of a circular annulus of triangular meridian cross section and small size, then in ejecting the bead 6 from the seat 10 outwards using a tire lever.

The bead 5 is then made to negotiate the safety hump 24 of the seat 20 inwardly using a tire-mounting roller 60 exerting pressure towards the inside of the rim, with the tire and wheel assembly rotating. This step is illustrated in FIG. 9.

FIG. 10 illustrates the final step which consists in causing the bead 5 to negotiate the seat 10 outwardly, still using the tire-mounting roller 60. It should be noted that the hump 32 separating the grooves 40 and 50 also plays an important part in removing the tire by, just as it did when fitting the tire, restricting the extent to which the tire can become skewed and thus making it easier to negotiate the seat. What actually happens is that the bead 5 becomes immobilized against the hump 32 instead of having a tendency to slide towards the seat 20.

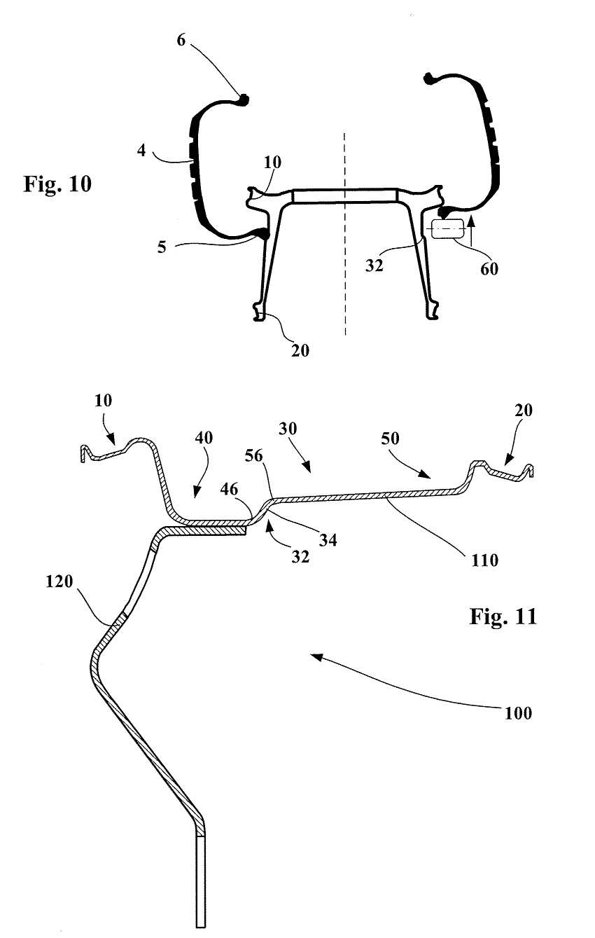

FIG. 11 shows a wheel 100 made up of a disc 120 and of a rim 110. The disc and the rim are both made from sheet metal. The disc is assembled with the rim under the mounting groove 40. This mounting groove has the deeper depth Hₘₐₓ and is adjacent to the seat 10. The rim 110 is entirely similar to the one shown in FIG. 1 except for the hump 32 which comprises an additional part that is frustoconical of revolution and positioned between the parts 46 and 56 which locally coincide with a torus of revolution. That makes it possible to increase the radial magnitude of the hump 32.

The invention is not restricted to the examples described and depicted and various modifications can be made thereto without departing from the scope which is limited only by the claims which follow.

What is claimed is:

1. A vehicle rim with symmetry of revolution for mounting a tire, comprising a first seat capable of receiving and retaining a first bead of said tire; a mounting groove; and a second seat capable of receiving and retaining a second bead of said tire, said second seat having an average diameter smaller than an average diameter of said first seat, wherein the maximum radial depth of said mounting groove (Hₘₐₓ) is such that said second bead can negotiate said first seat.

2. The vehicle rim according to claim 1, wherein the maximum radial depth of said mounting groove (Hₘₐₓ) is a function of a maximum diameter (Ø_{S1max}) of said first seat and of a minimum diameter (Ø_{S2min}) of said second seat:
$${H}_{max} = \frac{( {Ø}_{S 1 max} - {Ø}_{GM min} )}{2} = F ( {Ø}_{S 1 max} , {Ø}_{S 2 min} )$$
where Ø_{GMmin} is a minimum diameter of the mounting groove.

3. The vehicle rim according to claim 2, wherein said mounting groove further comprises a first sidewall adjacent to said first seat; a bottom; and a second sidewall adjacent to said second seat and wherein the minimum-diameter region (Ø_{GMmin}) of the mounting groove is adjacent to the first sidewall.

4. The vehicle rim according to claim 3, wherein the minimum depth of the bottom of the said mounting groove (Hₘᵢₙ) is a function of maximum (Ø_{S2max}) and minimum (Ø_{S2min}) diameters of said second seat:
$$H min = \frac{{Ø}_{S 1 max} - {Ø}_{GM max}}{2} = G ( {Ø}_{S 2 max} , {Ø}_{S 2 min} )$$
where Ø_{GMmax} is a maximum diameter of the bottom of the mounting groove.

5. The vehicle rim according to claim 3 or 4, wherein the bottom of said mounting groove comprises a zone that is substantially cylindrical of revolution, wherein said zone is followed on the same side as the second seat by a frustoconical zone that locally coincides with a cone of revolution open towards said second seat.

6. The vehicle rim according to claim 5, wherein said zone that is substantially cylindrical of revolution and said frustoconical zone are separated by a hump.

7. The vehicle rim according to claim 6, wherein said hump locally coincides with 1) a first torus of revolution coaxial with and external to said rim and 2) a second torus of revolution coaxial with and external to said rim, wherein said second torus is on the same side as the second seat.

8. The vehicle rim according to claim 7, wherein said hump comprises a zone that is frustoconical of revolution positioned between said first torus of revolution and said second torus of revolution.

9. The vehicle rim according to claim 1, 2, 3, 4, 5, 6, 7 or 8 wherein said first seat is intended to be positioned on the outboard side of a vehicle.

10. The vehicle rim according to claim 9, wherein said first seat comprises:
a frustoconical bottom which locally coincides with a cone of revolution coaxial with the rim and open towards the second seat,
a safety hump extending the bottom of the first seat towards the second seat, and
an outer edge extending the bottom of the first seat on the opposite side to the second seat.

11. The vehicle rim according to claim 10, wherein said second seat comprises:
a frustoconical bottom which locally coincides with a cone of revolution coaxial with the rim and open towards the first seat,
a safety hump extending the bottom of the second seat towards the first seat, and
an outer edge extending the bottom of the first seat on the opposite side to the second seat.

12. The vehicle rim according to claim 1 wherein said rim is made from sheet metal.

13. A vehicle wheel comprising a rim according to claim 12, and a disc made from sheet metal, wherein the disc and the rim are assembled by fitting the disc and the rim together under a part of the mounting groove that is adjacent to the first seat of the rim.

14. A method of mounting a tire on a wheel having a rim according to claim 11, said method comprising:
1) inserting part of the second bead into the mounting groove of the rim by negotiating the first seat;
2) achieving negotiating the first seat with the second bead of the tire;
3) negotiating the second seat with the second bead of the tire; and
4) placing the two beads of the tire on the respective seats of the said rim.

15. The method according to claim 14, further comprising immobilizing the second bead against an intermediate hump of the said mounting groove while inserting part of the second bead into the mounting groove of the rim.

16. The method according to claim 14 or 15, further comprising:
1) rotating the tire about an axis perpendicular to the axis of the wheel wherein at least the second bead straddles the second seat of the said rim once the second bead of the tire finishes negotiating the first seat; and then
2) placing the two beads of the tire in turn on the respective seats of the said rim using a tire-mounting roller.

17. The method according to claim 16, further including positioning a bead that is straddling a rim seat said positioning comprising:
1) fitting said bead on the said seat prompted by a relative axial rotational movement of the tire and of the rim;
2) positioning a tire-mounting roller to bear axially partially against the outer edge of the seat of the said rim and partially against the bead of the said tire in the region where the bead is in place on the said seat;
3) rotating the wheel and tire assembly in a direction of rotation such that the tire-mounting roller comes into contact with a part of the bead that is positioned on the outside of the seat and is not yet in place on said seat and
4) continuing step 3) until said bead is fully in place on said seat.

18. A method of removing a tire from a wheel comprising a rim according to claim 11, comprising:
1) dislodging the first bead from its seating axially outwards;
2) negotiating the safety hump of the second seat with the second bead axially in the direction of the mounting groove;
3) moving the second bead towards the first seat of said rim while bearing against the hump of said mounting groove; and
4) negotiating the first seat with the second bead.

19. A method of removing a tire from a wheel comprising a rim according to claim 11 said method comprising:
1) negotiating the safety hump of the second seat with the second bead axially in the direction of the mounting groove;
2) dislodging the first bead from its seating axially outwards;
3) moving the second bead towards the first seat of the said rim while bearing against the hump of the said mounting groove; and
4) negotiating the first seat with the second bead.
